(19) United States
(12) Patent Application Publication
(10) Pub. No.: US 2024/0296988 A1
(43) Pub. Date: Sep. 5, 2024

(54) TRANSFORMER ASSEMBLY

(71) Applicant: Murata Manufacturing Co., Ltd., Nagaokakyo-shi (JP)

(72) Inventors: Hongzhong MA, Dongguan City (CN); Qiongzhen YAN, Dongguan City (CN)

(21) Appl. No.: 18/593,416

(22) Filed: Mar. 1, 2024

(30) Foreign Application Priority Data
Mar. 3, 2023 (CN) 202310201184.7

(51) Int. Cl. H01F 27/04; H01F 27/38; H01F 27/40; H01F 29/02

(52) U.S. Cl. CPC H01F 27/04; H01F 27/38; H01F 27/40; H01F 29/025

(57) ABSTRACT

A transformer assembly includes a transformer module including a plurality of transformer units and a separation magnetic core between adjacent transformer units. Each of the plurality of transformer units includes a first magnetic column, and a primary winding and a secondary winding respectively wound around the first magnetic column. The primary windings of the plurality of transformer units are connected in series.

### CROSS-REFERENCE TO RELATED APPLICATIONS

The present application claims priority to Chinese patent application No. 202310201184.7, filed on Mar. 3, 2023, and the entire disclosure of which application is incorporated herein by reference.

### BACKGROUND OF THE INVENTION

### 1. Field of the Invention

The present disclosure generally relates to transformer technologies, and more particularly, to transformer assemblies.

### 2. Description of the Related Art

At present, in an Electric Vehicle (EV), an externally input charging voltage of about 400 V is converted into a voltage of about 12 V to about 14 V which an on-board battery can withstand through a Direct Current-Direct Current (DC-DC) converter. With development of this technology, the charging voltage tends to increase from about 400 V to about 800 V to shorten a charging time and improve efficiency, which will result in challenges to the design of a primary transformer in the DC-DC converter. In a solar charging field, the above challenges also exist.

### SUMMARY OF THE INVENTION

Example embodiments of the present disclosure reduce AC loss and improve heat dissipation performance of transformers, especially when the transformers are used in high-frequency applications and high-voltage conversion scenarios.

In an example embodiment of the present disclosure, a transformer assembly includes a plurality of transformer units, each of the plurality of transformer units includes a first magnetic column, and a primary winding and a secondary winding respectively wound around the first magnetic column. The transformer assembly further includes a transformer separation magnetic core provided between adjacent transformer units of the plurality of transformer units, and the primary windings of the plurality of transformer units are connected in series.

Optionally, the plurality of transformer units are arranged in sequence along an axial direction of the first magnetic columns.

Optionally, the primary winding of each transformer unit is located between the secondary winding and the first magnetic column along a radial direction of the first magnetic column.

Optionally, each of the plurality of transformer units further includes a bracket which is cylindrical that can define a sleeve around the first magnetic column, and the primary winding is wound around the bracket.

Optionally, each of the plurality of transformer units further includes a first cover plate, a first base plate, and a first side plate, wherein the first cover plate and the first base plate are respectively located at two ends of the first magnetic column along an axial direction of the first magnetic column, and the first side plate is located between the first cover plate and the first base plate.

Optionally, the first side plate surrounds approximately half to approximately three quarters of an outer circumferential surface of the first magnetic column along a circumferential direction of the first magnetic column.

Optionally, the adjacent transformer units include a first transformer unit and a second transformer unit, and the first base plate of the first transformer unit is the first cover plate of the second transformer unit.

Optionally, the transformer separation magnetic core is the first base plate of the first transformer unit and the first cover plate of the second transformer unit.

Optionally, the secondary windings of the plurality of transformer units are connected in parallel and/or in series.

Optionally, when the secondary windings of the plurality of transformer units are connected in parallel, a number of output terminals of the transformer module is equal to a number of taps of the secondary windings of the plurality of transformer units.

Optionally, the secondary winding includes a high voltage winding to output a high voltage and/or a low voltage winding to output a low voltage.

Optionally, the high voltage winding and the primary winding are wound together on the first magnetic column.

Optionally, the secondary windings of at least a portion of the plurality of transformer units include both the high voltage winding and the low voltage winding.

Optionally, the transformer assembly further includes an output inductor array including a plurality of output inductors, where an inductor separation magnetic core is located between adjacent output inductors, and an input terminal of each of the plurality of output inductors is coupled to a corresponding output terminal of the transformer module.

Optionally, a number of output terminals of the transformer module corresponds to a number of taps of the secondary windings, and a number of the plurality of output inductors is equal to the number of the output terminals of the transformer module.

Optionally, the plurality of output inductors are arranged in sequence along a first direction parallel or substantially parallel to an axial direction of the first magnetic columns.

Optionally, each of the plurality of output inductors includes a second magnetic column, a first winding wound around the second magnetic column, a second cover plate, a second base plate, and a second side plate, wherein the second cover plate and the second base plate are respectively located at two ends of the second magnetic column along an axial direction of the second magnetic column, and the second side plate is located between the second cover plate and the second base plate.

Optionally, the adjacent output inductors include a first output inductor and a second output inductor, and the second base plate of the first output inductor is the second cover plate of the second output inductor.

Optionally, the transformer assembly further includes a first resonant inductor coupled to an input terminal of the transformer module, where the first resonant inductor is located along the axial direction of the first magnetic columns, at either end of the transformer module or between any two adjacent transformer units.

Optionally, the first resonant inductor includes a third magnetic column and a second winding wound around the third magnetic column, and a third cover plate, a third base plate and a third side plate, where the third cover plate and the third base plate are respectively located at two ends of the third magnetic column along an axial direction of the third magnetic column, and the third side plate is located between the third cover plate and the third base plate.

Optionally, the second winding is connected in series with the primary windings of the plurality of transformer units.

Optionally, the plurality of adjacent transformer units includes an adjacent transformer unit that is adjacent to the first resonant inductor, and the third cover plate or the third base plate of the first resonant inductor is the first base plate or the first cover plate of the adjacent transformer unit.

Optionally, the transformer assembly further includes a second resonant inductor coupled to at least one secondary winding, where the second resonant inductor is located along the axial direction of the first magnetic column, at either end of the transformer module or between any two adjacent transformer units.

Optionally, the second resonant inductor includes a fourth magnetic column, a third winding wound around the fourth magnetic column, a fourth cover plate, a fourth base plate, and a fourth side plate, where the fourth cover plate and the fourth base plate are respectively located at two ends of the fourth magnetic column along an axial direction of the fourth magnetic column, and the fourth side plate is located between the fourth cover plate and the fourth base plate.

Optionally, the at least one secondary winding includes a high voltage winding, and the second resonant inductor and the high voltage winding are connected in series.

Optionally, the plurality of adjacent transformer units includes an adjacent transformer unit that is adjacent to the first resonant inductor, and the fourth cover plate or the fourth base plate of the second resonant inductor is the first base plate or the first cover plate of the adjacent transformer unit.

Optionally, the transformer assembly further includes a first resonant inductor coupled to an input terminal of the transformer module, where the first resonant inductor is located, along the axial direction of the first magnetic columns, at either end of the transformer module, or between any two adjacent transformer units, or between the second resonant inductor and an adjacent transformer unit.

Example embodiments of the present disclosure may provide one or more of the following advantages.

Example embodiments of the present disclosure provide a transformer assembly including a plurality of transformer units, where a separation magnetic core is provided between adjacent transformer units, each of the plurality of transformer units includes a first magnetic column, and a primary winding and a secondary winding respectively wound around the first magnetic column, and the primary windings of the plurality of transformer units are connected in series.

The example embodiments of the present disclosure may achieve lower AC losses and better heat dissipation performance, while meeting the requirements of high-frequency applications and high-voltage conversion. Compared with existing solutions that a transformer only includes a single magnetic flux loop on both a primary side and a secondary side, in the example embodiments of the present disclosure, the separation magnetic core causes magnetic paths of adjacent transformer units to not affect each other, and thus multiple independent primary flux loops and multiple independent secondary flux loops are formed in the transformer module. Further, a cascade design of multiple transformer units prevents the primary windings and secondary windings in the transformer module from stacking together, which is conducive to enhancing heat dissipation performance. Further, the design of the transformer module is more flexible. For example, power capability may be adjusted by increasing or decreasing the number of transformer units to meet needs of different application scenarios.

On the primary side, the primary windings are connected in series, and a number of coil turns required for high-voltage conversion is equivalent to a sum of the number of coil turns of each primary winding, so that each of the plurality of transformer units shares a portion of an input high voltage. As the input voltage to which each transformer unit is coupled is reduced, the number of turns of the primary winding in each transformer unit is reduced. Accordingly, magnetic induction intensity in the magnetic path of each primary winding is small, and leakage inductance and winding capacitance are also lower, thus reducing AC losses.

On the secondary side, the secondary windings may be connected in parallel. Specifically, the secondary windings are connected in parallel so that each of the plurality of transformer units shares a portion of an output high current. Reducing the output current of each transformer unit on the secondary side is conducive to avoiding damage to the output terminal due to a high current. Further, the cascade design of multiple transformer units increases the number of the output terminals of the transformer module, which is equivalent to an increase in a contact area on the secondary side, which is conducive to reducing contact resistance and enhancing heat dissipation performance. Compared with existing solutions where a transformer includes only a single secondary magnetic flux loop and thus all the secondary windings are required to be welded together, in the example embodiments of the present disclosure, solder joints of each secondary winding are eliminated, which is conducive to reducing process complexity and further improving a yield rate.

Alternatively, on the secondary side, the secondary windings may be connected in series. In this case, the transformer module may operate in both directions, that is, the transformer module may include primary side input and secondary side output, or secondary side input and primary side output. By connecting the secondary windings in series to allow the transformer module to operate in both directions, the transformer module may better meet the requirements of transformer applications in the solar charging field.

Further, the transformer assembly further includes an output inductor array including a plurality of output inductors, where a separation magnetic core is located between adjacent output inductors, and an input terminal of each of the plurality of output inductors is coupled to a corresponding output terminal of the transformer module. Therefore, integrating the output inductors and the transformer is conducive to improving integration of devices in a DC-DC converter, reducing the number of components, and reducing costs. Further, the output inductor array formed by cascading the plurality of output inductors increases the total input terminals, improves heat conduction performance, and helps to reduce contact resistance so as to improve efficiency. Further, the design of the output inductor array is more flexible. For example, power capability may be adjusted by increasing or decreasing the number of output inductors to meet the requirements of different application scenarios.

Further, the secondary winding includes a high voltage winding to output a high voltage, and a low voltage winding to output a low voltage. Therefore, the transformer assembly in the example embodiments can charge a high voltage battery and a low voltage battery simultaneously.

Further, the transformer assembly further includes a first resonant inductor coupled to the input terminal of the transformer module, where the first resonant inductor is located, along the axial direction of the first magnetic columns, at either end of the transformer module or between any two adjacent transformer units. Therefore, integrating the resonant inductor on the primary side and the transformer helps to improve the integration of devices in the DC-DC converter, thus making the transformer assembly applicable to an LLC topology.

Further, the transformer assembly further includes a second resonant inductor coupled to at least one secondary winding, where the second resonant inductor is located, along an axial direction of the first magnetic columns, at either end of the transformer module or between any two adjacent transformer units. As a result, the resonant inductor on the primary side, the transformer, and the resonant inductor on the secondary side can be integrated together, which is conducive to improving the integration of devices in the DC-DC converter, thus making the transformer assembly applicable to a CLLC topology.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic diagram of a transformer assembly according to an example embodiment of the present invention.

FIG. 2 is an exploded view of a transformer module shown in FIG. 1.

FIGS. 3 and 4 are schematic diagrams of a manufacturing process of a secondary winding shown in FIG. 1.

FIG. 5 is a schematic diagram of a transformer assembly according to an example embodiment of the present invention.

FIG. 6 is a bottom view of the transformer assembly shown in FIG. 5.

FIG. 7 is an exploded view of an output inductor array shown in FIG. 5.

FIG. 8 is a schematic diagram of a first winding shown in FIG. 7.

FIG. 9 is a circuit principle diagram of a DC-DC converter in a first typical application scenario according to an example embodiment of the present invention.

FIG. 10 is a schematic diagram of a transformer assembly according to an example embodiment of the present invention.

FIG. 11 is an exploded view of the transformer assembly shown in FIG. 10.

FIG. 12 is a circuit principle diagram of an on-board charging circuit in a second typical application scenario according to an example embodiment of the present invention.

FIG. 13 is a schematic diagram of a transformer assembly according to an example embodiment of the present invention.

FIG. 14 is an exploded view of the transformer assembly shown in FIG. 13.

FIG. 15 is a circuit principle diagram of an LLC topology in a third typical application scenario according to an example embodiment of the present invention.

FIG. 16 is a schematic diagram of a transformer assembly according to an example embodiment of the present invention.

FIG. 17 is an exploded view of the transformer assembly shown in FIG. 16.

FIG. 18 is a circuit principle diagram of a CLLC topology in a fourth typical application scenario according to an example embodiment of the present invention.

FIG. 19 is a schematic diagram of a transformer assembly according to an example embodiment of the present invention.

FIG. 20 is an exploded view of the transformer assembly shown in FIG. 19.

FIG. 21 is a schematic diagram of a secondary winding shown in FIG. 19.

### DETAILED DESCRIPTION OF THE EXAMPLE EMBODIMENTS

As discussed above, with the increase of the charging voltage, the design of DC-DC converters, especially the primary transformer, faces great challenges.

Specifically, existing transformer structures are usually as follows. In two E-shaped magnetic cores, a primary winding and multiple secondary windings are stacked in sequence. Among the multiple secondary windings, every two adjacent secondary windings are separated by an insulating tape, and the multiple secondary windings are connected through external pins.

Such a transformer includes only one magnetic flux loop on both the primary side and the secondary side. It is necessary to increase a number of coil turns of the primary winding to handle a high voltage input. For example, in an on-board battery charging scenario of an electric vehicle, if an input voltage increases from about 400 V to about 800 V, the number of coil turns of the primary winding in the existing transformer needs to be doubled. As the number of coil turns increases, leakage inductance and winding capacitance of the transformer also increase accordingly, resulting in high AC losses and lower efficiency (such as lower charging efficiency). In addition, the insulating tape between the coils is also prone to produce parasitic capacitance, which also increases AC losses and reduces efficiency.

On the other hand, the primary windings and secondary windings are stacked in layers and arranged in sequence without gaps, which impacts the heat dissipation performance of the transformer. In addition, the multiple secondary windings need to be connected together through the external pins, which requires high welding processes and increases the difficulty of a manufacturing process.

Example embodiments of the present disclosure provide a transformer assembly including a plurality of transformer units, where a separation magnetic core is provided between adjacent transformer units, each of the plurality of transformer units includes a first magnetic column, and a primary winding and a secondary winding respectively wound around the first magnetic column, and the primary windings of the plurality of transformer units are connected in series.

The example embodiments of the present disclosure may achieve lower AC losses and better heat dissipation performance while meeting the requirements of high-frequency applications and high-voltage conversion. Compared with existing solutions in which a transformer only includes a single magnetic flux loop on both a primary side and a secondary side, in the example embodiments of the present disclosure, the separation magnetic core causes magnetic paths of adjacent transformer units to not affect each other, and thus multiple independent primary flux loops and multiple independent secondary flux loops are provided in the transformer module. Further, a cascade design of multiple transformer units prevents the primary windings and the secondary windings in the transformer module from stacking together, which is conducive to enhancing heat dissipation performance. Further, the design of the transformer module is more flexible. For example, the power capability may be adjusted by increasing or decreasing the number of the transformer units to meet the requirements of different application scenarios.

On the primary side, the primary windings are connected in series, and a number of coil turns required for high-voltage conversion is equivalent to the sum of the number of coil turns of each primary winding, so that each of the plurality of transformer units shares a portion of an input high voltage. As the input voltage to which each transformer unit is coupled is reduced, the number of turns of the primary winding in each transformer unit is reduced. Accordingly, magnetic induction intensity in the magnetic path of each primary winding is small, and leakage inductance and winding capacitance are also lower, thus reducing AC losses.

On the secondary side, the secondary windings may be connected in parallel. Specifically, the secondary windings are connected in parallel so that each of the plurality of transformer units shares a portion of an output high current. Reducing the output current of each transformer unit on the secondary side is conducive to avoiding damage to the output terminal due to a high current. Further, the cascade design of multiple transformer units increases the number of the output terminals of the transformer module, which is equivalent to an increase in a contact area on the secondary side, which is conducive to reducing contact resistance and enhancing heat dissipation performance. Compared with existing solutions where a transformer includes only a single secondary magnetic flux loop and thus all the secondary windings are required to be welded together, in the example embodiments of the present disclosure, solder joints of each secondary winding are eliminated, which is conducive to reducing process complexity and further improving a yield rate.

Alternatively, on the secondary side, the secondary windings may be connected in series. In this case, the transformer module may operate in both directions, that is, it may be primary side input and secondary side output, or secondary side input and primary side output. By connecting the secondary windings in series to allow the transformer module to operate in both directions, it may better meet the requirements of transformer applications in the solar charging field.

Hereinafter, example embodiments of the present disclosure are described in detail with reference to the drawings. In each figure, the same element is labeled with the same reference number. Each example embodiment is only a non-limiting example, and it is certainly possible to partially replace or combine structures shown in different example embodiments. In modified examples, description of matters common to a foregoing example embodiment is omitted, and only differences are described. In particular, the same effect produced by the same structure is not repeated in each example embodiment.

In order to make the above elements, characteristics, features, and beneficial effects of the present invention more obvious and understandable, specific example embodiments of the present invention will be described in detail below with reference to the accompanying drawings.

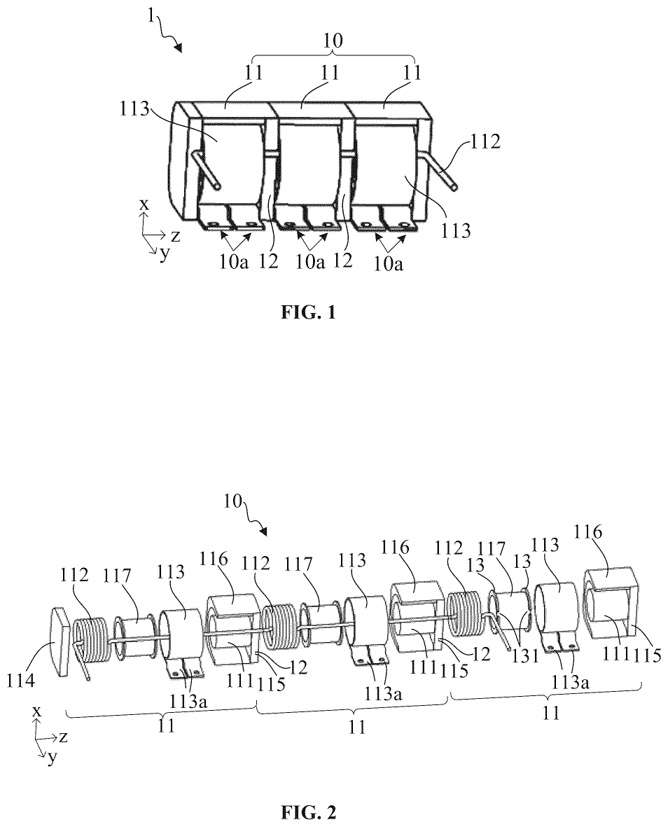

FIG. 1 is a schematic diagram of a transformer assembly 1 according to an example embodiment, and FIG. 2 is an exploded view of a transformer module 10 shown in FIG. 1.

The transformer assembly 1 in the present example embodiment may be applied in on-board charging scenarios, such as a DC-DC converter integrated in an electric vehicle, to realize voltage conversion between an external power supply module and an on-board battery. An input voltage provided by the power supply module may be, for example, about 800 volts (V), and an operation voltage of the on-board battery may be, for example, about 12 V.

Specifically, referring to FIGS. 1 and 2, the transformer assembly 1 may include the transformer module 10. The transformer module 10 may include a plurality of transformer units 11, with a separation magnetic core 12 located between adjacent transformer units 11. For example, m transformer units 11 and (m-1) separation magnetic cores 12 may be arranged at intervals along the same direction, where m is a positive integer greater than or equal to 2. FIGS. 1 and 2 take m=3 as an example for illustrative display. In practice, a specific value of m may be adjusted based on the input voltage to be converted, space size constraints of an environment where devices are located, and other factors.

Further, each transformer unit 11 may include a first magnetic column 111, a first cover plate 114, a first base plate 115, and a first side plate 116. The first cover plate 114 and the first base plate 115 are located at two ends of the first magnetic column 111 along an axial direction of the first magnetic column 111, and the first side plate 116 is located between the first cover plate 114 and the first base plate 115.

For each transformer unit 11, the first base plate 115 and the first cover plate 114 of the transformer unit 11 may be parallel or substantially parallel, within manufacturing and/or measurement tolerances to each other.

For example, the transformer module 10 may have a length direction (x direction in the figure), a width direction (y direction in the figure) and a height direction (z direction in the figure) which are perpendicular to each other. A direction (i.e., the axial direction of the first magnetic column 111) from the first cover plate 114 to the first base plate 115 of the transformer unit 11 defines the height direction (z direction in the figure). In a plane perpendicular to the z direction, two adjacent sides of the first base plate 115 respectively define the length direction (x direction in the figure) and the width direction (y direction in the figure).

The plurality of transformer units 11 may be arranged in sequence along the z direction, that is, the transformer units 11 may be arranged in sequence along the axial direction of the first magnetic column 111.

Further, the first cover plate 114 of one of two adjacent transformer units 11 may share the first base plate 115 of the other of the two adjacent transformer units 11. For example, among the three transformer units 11 shown in FIGS. 1 and 2, the first cover plate 114 of the transformer unit 11 on the right shares the first base plate 115 of the transformer unit 11 on the left. As a result, length of the transformer module 10 along the z direction is reduced, which is conducive to device miniaturization design. Further, the separation magnetic core 12 may include the first base plate 115 or the first cover plate 114 shared by the adjacent transformer units 11, which is conducive to further reducing the length of the transformer module 10 along the z direction and achieving a compact design.

The first cover plate 114, the first base plate 115, the first side plate 116, the first magnetic column 111 and the separation magnetic core 12 may be made of manganese-zinc ferrite, nickel-zinc ferrite, or other magnetic core body materials to increase magnetic induction intensity of the transformer unit 11.

Further, an air gap may be provided at any position of the first magnetic column 111 to prevent magnetic saturation of the transformer unit 11 during operation. For example, the air gap may be provided at an interface between the first magnetic column 111 and the corresponding first cover plate 114, and at the interface between the first magnetic column 111 and the corresponding first base plate 115.

Further, the first magnetic column 111, the first side plate 116, and the first base plate 115 may be integrally formed to form an E-shaped magnetic core structure or may be bonded together during assembly.

Further, each transformer unit 11 may include a primary winding 112 wound around the first magnetic column 111. The design of the separation magnetic cores 12 makes a common magnetic core sandwiched between each two primary windings 112, so that each transformer unit 11 can form an independent primary magnetic flux loop, and thus the entire transformer module 10 includes multiple magnetic paths on the primary side.

It should be noted that FIG. 2 only illustrates the primary windings 112 exemplarily. In practice, those skilled in the art can adjust a number of coil turns and winding density of the primary windings 112 as needed.

Further, the primary windings 112 wound around each transformer unit 11 may have the same winding direction or different winding directions. For example, the winding directions of the primary windings 112 of adjacent transformer units 11 on the corresponding first magnetic columns 111 may be opposite, so that magnetic fluxes of the adjacent transformer units 11 cancel each other out in the separation magnetic core 12, thus reducing the losses and size of the magnetic cores.

Further, the number of coil turns and winding density of the primary windings 112 wound on different transformer units 11 may be the same or different. Accordingly, on the primary side, the magnetic induction intensity generated by each transformer unit 11 may be the same or different according to the number of coil turns of the primary winding 112 wound around each transformer unit 11.

Further, the primary windings of the transformer units 11 may be connected in series. Accordingly, on the primary side, the total magnetic induction intensity of the transformer module 10 may be a sum of the magnetic induction intensity of each transformer unit 11, so that the total input voltage of the transformer module 10 is distributed to each primary winding 112. Therefore, on the premise of ensuring that the primary side can withstand a relatively high input voltage, each transformer unit 11 can handle the distributed input voltage by winding the primary winding 112 with a relatively small number of coil turns. The reduction in the number of coil turns causes the magnetic field intensity in the magnetic path of each transformer unit 11 to be smaller and the AC losses to be lower.

Further, referring to FIG. 2, the primary windings 112 of the transformer units 11 may be wound by the same wire. For example, each transformer unit 11 may include a bracket 117 which is cylindrical that can define a sleeve around the first magnetic column 111, and the primary winding 112 may be wound around the bracket 117. For example, the bracket 117 may include a hollow portion extending to both ends along the z direction. During assembly, the primary winding 112 is first wound around the bracket 117, and then the first magnetic column 111 is inserted into the hollow portion, thus the primary winding 112 is wound around the first magnetic column 111.

Further, both ends of the bracket 117 along the z direction may include outwardly folded flanges 13, each of which may be provided with a notch 131. A wire segment connecting the primary windings 112 of two adjacent transformer units 11 is at least partially located in the notch 131. That is, when the same wire is used to wind the primary windings 112 of the transformer units 11, at least a section of the wire spanning the adjacent transformer units 11 is embedded in the notch 131, which, on one hand, can play a positioning and fixing role, and on the other hand, can prevent the wire from being damaged due to unexpected movement.

For example, the bracket 117 may be made of plastic to provide insulation and support.

Further, referring to FIGS. 1 and 2, each transformer unit 11 may include a secondary winding 113 wound around the first magnetic column 111.

Along a radial direction of the first magnetic column 111, the primary winding 112 of the same transformer unit 11 may be located between the secondary winding 113 and the first magnetic column 111. That is, for each transformer unit 11, the secondary winding 113 radially surrounds the primary winding 112.

Further, along a circumferential direction of the first magnetic column 111, the first side plate 116 may surround approximately one-half to approximately three-quarters, within manufacturing and/or measurement tolerances, of an outer circumferential surface of the first magnetic column 111. As the primary winding 112 is wound around the first magnetic column 111, and the secondary winding 113 is further wound around the outside of the primary winding 112, it can also be understood that the first side plate 116 surrounds at least a portion of an outer peripheral surface of the secondary winding 113. A surrounding area of the first side plate 116 may be approximately three-quarters, within manufacturing and/or measurement tolerances, of the outer circumferential surface of the secondary winding 113. For example, a shape of each transformer unit 11 is similar to a cube or cuboid, and the first side plate 116 may be located on three sides of the cube or cuboid that are parallel or substantially parallel, within manufacturing and/or measurement tolerances, to the z direction.

In an assembled state as shown in FIG. 1, the first cover plate 114 and the first base plate 115 are configured to seal along the z direction two ends of the first magnetic column 111, the primary winding 112 and the secondary winding 113 are wound around the first magnetic column 111, and the first side plate 116 is configured to seal at least a portion of the outer circumferential surface of the secondary winding 113. Therefore, the E-shaped magnetic core defined by the first base plate 115 and the first side plate 116 is wrapped around the outside of the secondary winding 113 and leaves a gap, which may improve efficiency and facilitate heat dissipation while maintaining miniaturization.

The first magnetic column 111 may be a cylinder. Accordingly, a space surrounded by the first side plate 116, the first base plate 115, and the first cover plate 114 may be a cylinder to match the shapes of the primary winding 112 and the secondary winding 113.

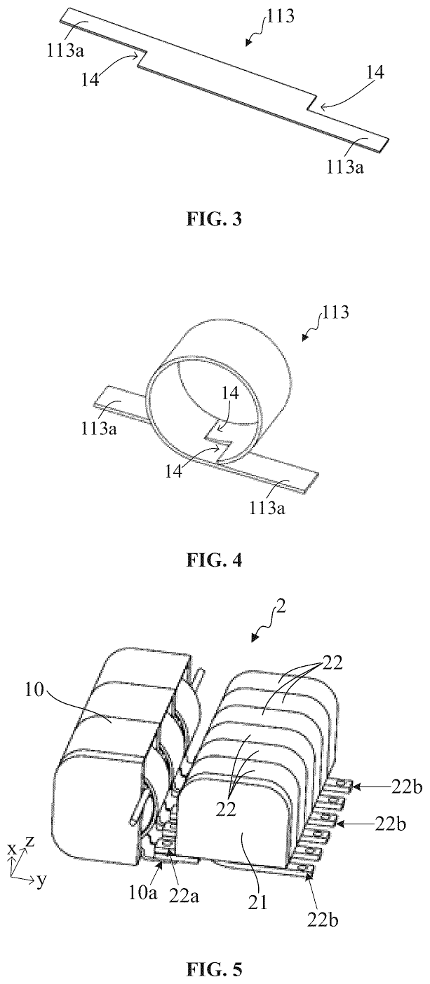

Further, the secondary winding 113 may include copper foil wound into a cylindrical shape. Referring to FIG. 3, the copper foil may be strip-shaped, and two ends along a length direction of the copper foil are suitable for forming taps 113a of the secondary winding 113, with steps 14 between the taps 113a and a main body of the copper foil. During assembly, the strip-shaped copper foil as shown in FIG. 3 may be wound around once to obtain a cylindrical shape as shown in FIG. 4. The steps 14 are suitable for limiting a degree of winding of the copper foil, that is, limiting a minimum diameter of the cylindrical structure into which the copper foil is wound. A portion of the copper foil extending beyond the cylindrical structure at both ends along the length direction forms the taps 113a of the secondary winding 113. Afterward, the tap 113a on one side is folded to the other side, the taps 113a are bent to form steps, and a through hole is formed at the end to form the secondary winding 113 including two taps 113a located on the same side as shown in FIGS. 1 and 2.

During assembly, after the bracket 117 wound with the primary winding 112 is inserted over the first magnetic column 111 to define a sleeve around the first magnetic column 111, the secondary winding 113 wound into a cylindrical shape can define a sleeve around the primary winding 112. Alternatively, the secondary winding 113 wound into a cylindrical shape may be placed outside the primary winding 112 first, and then inserted over the first magnetic column 111 to define a sleeve around the first magnetic column 111.

Afterward, the first base plate 115 of the adjacent transformer unit 11 or the first cover plate 114 is used to seal the secondary winding 113, the primary winding 112, the bracket 117 and the first magnetic column 111 in a space surrounded by the first cover plate 114 and the first base plate 115, and finally the transformer module 10 shown in FIG. 1 is obtained.

Further, an inner circumference of the secondary winding 113 may be covered with an insulating tape to isolate the secondary winding 113 and the primary winding 112 to strengthen insulation between the secondary winding 113 and the first magnetic column 111, insulation between the primary winding 112 and the secondary winding 113, and insulation between the secondary windings 113.

Further, the separation magnetic cores 12 allow the secondary windings 113 in each transformer unit 11 to operate independently, without the need to set up special joints to connect the secondary windings 113 together, which is conducive to reducing complexity of a manufacturing process.

Further, the tap 113a of the secondary winding 113 may be exposed outside the transformer unit 11, that is, located outside of a space surrounded by the first cover plate 114, the first base plate 115, and the first side plate 116, which is conducive to heat dissipation performance of the transformer unit 11.

Further, the secondary windings 113 of the transformer units 11 may be connected in parallel. On the secondary side, a total output current of the transformer module 10 is distributed to each secondary winding 113, so that each tap 113a of the secondary winding 113 needs to withstand a relatively small current, which is conducive to avoiding damage to devices.

Further, the number of output terminals 10a of the transformer module 10 may be associated with the number of the taps 113a of the secondary windings 113.

For example, the number of the output terminals 10a of the transformer module 10 may be equal to the number of the taps 113a of the secondary windings 113. As a result, the output terminals 10a of the transformer module 10 include more contact points in an applied circuit, which is conducive to reducing heat generated.

For another example, the taps 113a of at least a portion of the secondary windings 113 may correspond to one output terminal 10a of the transformer module 10, which facilitates flexible adjustment of the number of the output terminals 10a of the transformer module 10 according to practical requirements.

From above, the example embodiments of the present disclosure may achieve lower AC losses and better heat dissipation performance while meeting the requirements of high-frequency applications and high-voltage conversion. The separation magnetic core 12 causes magnetic paths of adjacent transformer units 11 to not affect each other, and thus multiple independent primary flux loops and multiple independent secondary flux loops are formed in the transformer module 10. Further, a cascade design of multiple transformer units prevents the primary windings 112 and secondary windings 113 in the transformer module 10 from stacking together, which is conducive to enhancing heat dissipation performance. Further, the design of the transformer module 10 is more flexible. For example, power capability may be adjusted by increasing or decreasing the number of the transformer units 11 to meet the requirements of different application scenarios.

On the primary side, the primary windings 112 are connected in series, and the number of coil turns required for high-voltage conversion is equivalent to the sum of the number of coil turns of each primary winding 112, so that each of the plurality of transformer units 11 shares a portion of an input high voltage. As the input voltage to which each transformer unit 11 is coupled is reduced, the number of turns of the primary winding 112 in each transformer unit 11 is reduced. Accordingly, magnetic induction intensity in the magnetic path of each primary winding 112 is small, and leakage inductance and winding capacitance are also lower, thus reducing AC losses.

On the secondary side, the secondary windings 113 may be connected in parallel, so that each of the plurality of transformer units 11 shares a portion of an output high current. Reducing the output current of each transformer unit 11 on the secondary side is conducive to avoiding damage to the output terminal 10a due to a high current. Further, the cascade design of multiple transformer units 11 increases the number of the output terminals 10a of the transformer module 10, which is equivalent to an increase in a contact area on the secondary side, which is conducive to reducing contact resistance and enhancing heat dissipation performance. Further, solder joints of each secondary winding 113 are eliminated, which is conducive to reducing process complexity and further improving a yield rate.

In some example embodiments, the first cover plates 114 and the first base plates 115 of adjacent transformer units 11 may be attached to each other and jointly form the separation magnetic core 12 that separates the adjacent transformer units 11. Therefore, each transformer unit 11 may be manufactured independently, and then the plurality of transformer units 11 may be bonded together, which may help to ease manufacturing of the transformer module 10.

In some example embodiments, the separation magnetic core 12 may be an additional partitioning plate made of a magnetic core body material. Both sides of the partitioning plate along the z direction are respectively bonded to the first cover plate 114 of one transformer unit 11 and the first base plate 115 of another transformer unit 11.

In some example embodiments, the bracket 117 may be eliminated, and accordingly, the primary winding 112 may be directly wound around the first magnetic column 111. In the present example embodiment, to facilitate winding, the first side plate 116 may surround a relatively small area of the outer circumferential surface of the first magnetic column 111, such as on both sides of the first magnetic column 111 along the x direction or the y direction to cumulatively surround half or approximately half, within manufacturing and/or measurement tolerances, of the outer peripheral surface of the first magnetic column 111.

Further, the primary winding 112 may be directly wound around the first magnetic column 111 in a self-adhesive shaping manner.

In some example embodiments, the two taps 113a of the secondary winding 113 may be located on both sides of the cylindrical structure, that is, the secondary winding 113 may be inserted over the primary winding 112 to define a sleeve around the primary winding 112 as shown in FIG. 4. Accordingly, the first side plate 116 may be provided with openings for the taps 113a of the secondary winding 113 on both sides to protrude from, or the first side plate 116 may not extend over the taps 113a of the secondary winding 113.

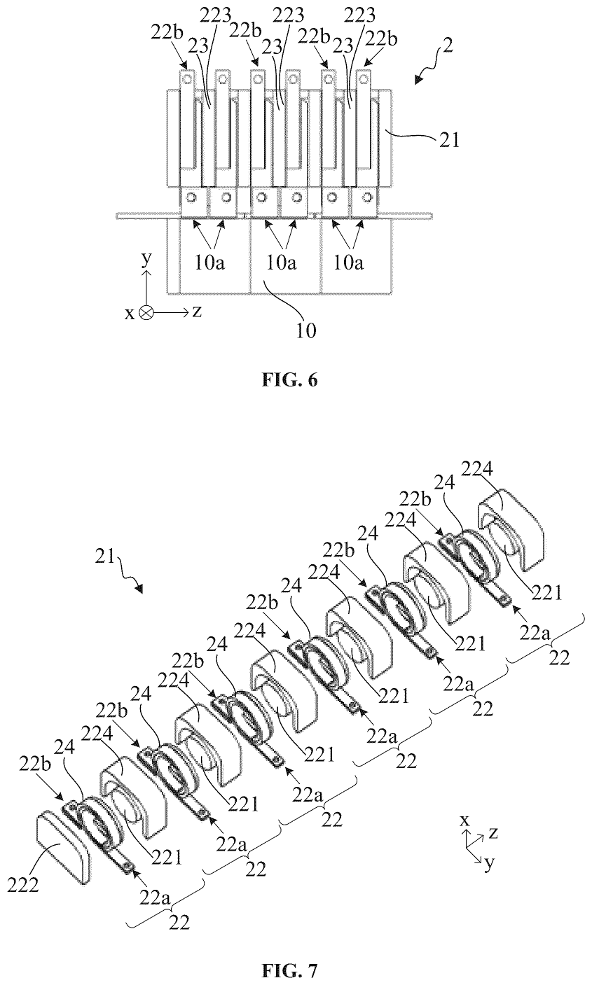

FIG. 5 is a schematic diagram of a transformer assembly 2 according to an example embodiment, FIG. 6 is a bottom view of the transformer assembly 2 shown in FIG. 5, and FIG. 7 is an exploded view of an output inductor array 21 shown in FIG. 5.

In the example embodiment of FIGS. 5 to 7, a difference from the above example embodiment in FIGS. 1 to 4 lies in that, in addition to the transformer module 10, the transformer assembly 2 further includes the output inductor array 21.

Specifically, referring to FIGS. 5 to 7, the output inductor array 21 may include a plurality of output inductors 22, and a separation magnetic core 23 may be provided between adjacent output inductors 22, where an input terminal 22a of each output inductor 22 is coupled to the corresponding output terminal 10a of the transformer module 10.

Further, the number of the plurality of output inductors 22 may be equal to the number of the output terminals 10a of the transformer module 10. That is, each output terminal 10a is coupled to one output inductor 22. As the tap 113a of each secondary winding 113 needs to withstand a relatively small current, the output inductor 22 coupled to the tap 113a has to withstand a relatively small current, thus better avoiding damage to devices.

FIGS. 5 and 6 illustrate each transformer unit 11 with two output terminals 10a. The number of the output inductors 22 is 6, and the output inductors 22 are coupled with the output terminals 10a respectively. In practice, a single transformer unit 11 may include one, two, three, or more output terminals 10a, and the number of the output inductors 22 in the output inductor array 21 may be adjusted based on the number of the output terminals 10a. In practice, there may be at least one transformer unit 11 whose number of output terminals 10a is different from the number of output terminals 10a of other transformer units 11. Accordingly, the number of the output inductors 22 connected to the at least one transformer unit 11 is different from the number of the output inductors 22 connected to other transformer units 11.

Further, a through hole is provided at the input terminal 22a of each output inductor 22, and a through hole is also provided at the output terminal 10a of the corresponding transformer module 10. The two through holes may be coaxially connected through a connecting member (not shown in the figures). The connecting member may be, for example, screws or solder joints.

Further, the plurality of output inductors 22 may be arranged in sequence along a first direction. The first direction is parallel or substantially parallel, within manufacturing and/or measurement tolerances, to the axial direction of the first magnetic column 111, that is, the plurality of output inductors 22 and the plurality of transformer units 11 may be arranged in sequence along the z direction.

Further, referring to FIG. 7, a single output inductor 22 may include a second magnetic column 221 and a first winding 24 wound around the second magnetic column 221. Further, the design of separation magnetic cores 23 causes magnetic paths of each output inductor 22 to be independent from each other.

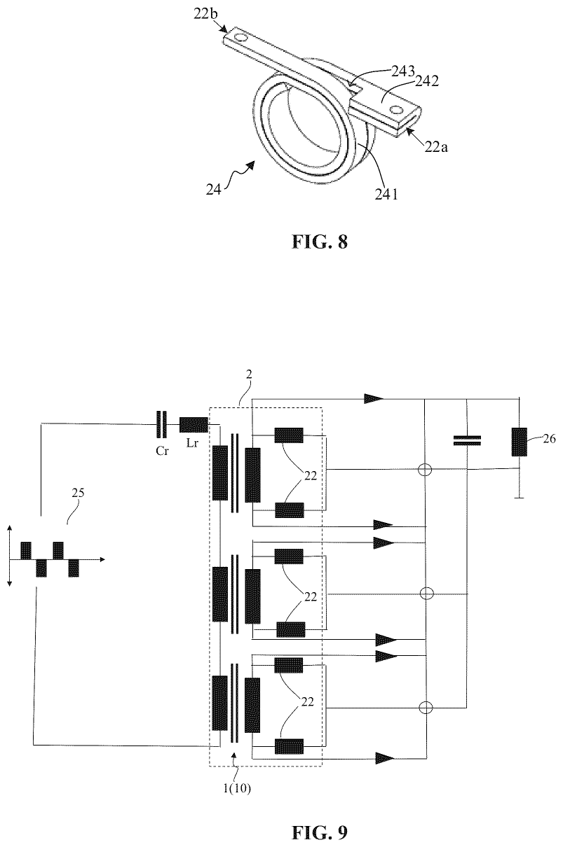

For example, referring to FIG. 8, the first winding 24 may be wound by a strip of copper foil, including an initially elongated main body portion 241 and a guide portion 242 which is located on one end of the main body portion 241 along a length direction of the main body portion 241 and partially overlapped with the main body portion 241 in a width direction of the main body portion 241. The elongated main body portion 241 is wound to form a cylindrical structure of the first winding 24. An end of the main body portion 241 spaced away from the guide portion 242 is configured to define the output terminal 22b of the output inductor 22, and an end of the guide portion 242 spaced away from the main body portion 241 is configured to define the input terminal 22a of the output inductor 22. A recessed portion 243 is provided between the end of the guide portion 242 spaced away from the main body portion 241 and the main body portion 241.

The end of the guide portion 242 spaced away from the main body portion 241 may have an area larger than that of the end of the main body portion 241 spaced away from the guide portion 242. In this manner, a contact area at the input terminal 22a of the output inductor 22 is larger, which is conducive to preventing the output inductor 22 from being damaged by a large current.

Further, each output inductor 22 may further include a second cover plate 222, a second base plate 223, and a second side plate 224. The second cover plate 222 and the second base plate 223 are located at two ends of the second magnetic column 221 along an axial direction (i.e., the z direction in the figure) of the second magnetic column 221, and the second side plate 224 is located between the second cover plate 222 and the second base plate 223.

For each output inductor 22, the second base plate 223 and the second cover plate 222 of the output inductor 22 may be parallel or substantially parallel, within manufacturing and/or measurement tolerances, to each other.

Further, along a circumferential direction of the second magnetic column 221, the second side plate 224 may surround approximately one-half to approximately three-quarters, within manufacturing and/or measurement tolerances, of an outer circumferential surface of the second magnetic column 221.

Further, the second cover plate 222 of one of two adjacent output inductors 22 may share the second base plate 223 of the other of the two adjacent output inductors 22. For example, among the six output inductors 22 shown in FIG. 7, the second cover plate 222 of the output inductor 22 on the right shares the second base plate 223 of the output inductor 22 on the left. As a result, length of the output inductor 22 along the z direction is reduced, which is conducive to miniaturization.

Further, the separation magnetic core 23 may include the second base plate 223 or the second cover plate 222 shared by adjacent output inductors 22, which is conducive to further reducing the length of the output inductor 22 along the z direction and achieving a compact design.

The second cover plate 222, the second base plate 223, the second side plate 224, the second magnetic column 221, and the separation magnetic core 23 may be made of manganese-zinc ferrite, nickel-zinc ferrite, and other magnetic core body materials to increase magnetic induction intensity of the output inductor 22.

Further, the second magnetic column 221, the second side plate 224, and the second base plate 223 may be integrally formed to form an E-shaped magnetic core structure. Alternatively, the three structures (i.e., the second magnetic column 221, the second side plate 224, and the second base plate 223) may be bonded together during assembly. The first winding 24 as shown in FIG. 8 obtained by winding strip copper foil can be inserted over the second magnetic column 221 of the E-shaped magnetic core structure to define a sleeve around the second magnetic column 221, and is then at least partially sealed by the second cover plate 222 or the second base plate 223 of the adjacent output inductor 22.

Integrating the output inductors 22 and the transformer (such as the transformer module 10 shown in the foregoing example embodiment) is conducive to improving integration of devices in the DC-DC converter, reducing the number of components, and reducing costs. Further, the output inductor array 21 formed by cascading the plurality of output inductors 22 increases the total number of input terminals 22a, improves heat conduction performance, and also helps to reduce contact resistance so as to improve efficiency. Further, the design of the output inductor array 21 is more flexible. For example, the power capability may be adjusted by increasing or decreasing the number of output inductors 22 to meet the requirements of different application scenarios.

In some example embodiments, the second cover plate 222 of one output inductor 22 and the second base plate 223 of the adjacent output inductor 22 may be attached to each other and jointly define the separation magnetic core 23 that separates the two adjacent output inductors 22. Therefore, each output inductor 22 may be manufactured individually and then bonded together, which may help to ease manufacturing of the output inductor array 21.

In some example embodiments, the separation magnetic core 23 may be an additional partitioning plate made of a magnetic core body material. The second cover plate 222 of one output inductor 22 and the second base plate 223 of another output inductor 22 are respectively bonded to both sides of the partitioning plate along the z direction.

In a first typical application scenario, the transformer assembly 2 shown in the foregoing example embodiment may be applied to a DC-DC converter, and FIG. 9 is a circuit principle diagram of a DC-DC converter coupled to the transformer assembly 2 shown in FIG. 5.

Specifically, referring to FIG. 9, an input terminal of the transformer module 10 may be coupled to a power supply module 25 which includes an output voltage V from about 0 V to about 1000 V, amplitude D from 0 to 1, and frequency f from about 10 kilohertz (KHz) to about 500 KHz. For example, on the primary side, the primary windings 112 of the transformer units 11 may be connected in series to the power supply module 25 via a resonant capacitor Cr and a resonant inductor Lr.

Further, an output terminal 10a of the transformer module 10 may be coupled to a load 26 which is configured to operate at a DC voltage of about 12 V and a current of about 50 amps (A), for example. For example, on the secondary side, the taps 113a of the secondary windings 113 of the transformer units 11 (that is, the output terminals 10a of the transformer module 10) are coupled one by one to the input terminals 22a of the corresponding output inductors 22, and the output terminals 22b of the output inductors 22 are connected in parallel to the load 26.

The DC-DC converter in the present example embodiment uses a backflow rectification topology transferring a portion of losses of the transformer module 10 to the output inductor array 21, which is conducive to improving efficiency and improving heat dissipation performance.

In another application scenario, the transformer assembly 1 shown in the above example embodiment of FIGS. 1 and 2 may be applied to the DC-DC converter shown in FIG. 9. Accordingly, on the secondary side, the taps 113a of the secondary windings 113 of the transformer units 11 may be coupled to any existing output inductor, and finally connected to the load 26.

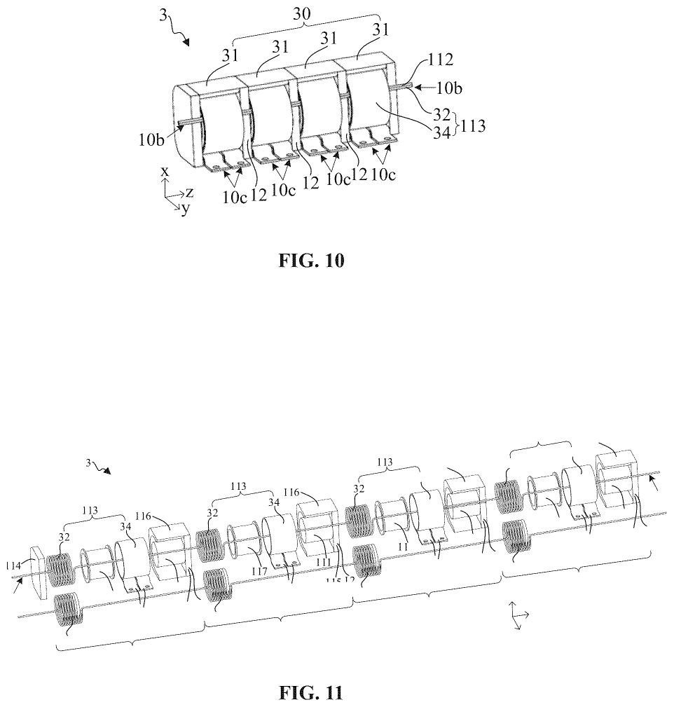

FIG. 10 is a schematic diagram of a transformer assembly 3 according to an example embodiment, and FIG. 11 is an exploded view of the transformer assembly 3 shown in FIG. 10.

In the example embodiment, the secondary winding 113 formed by winding copper foil in the transformer module 10 shown in the above example embodiment of FIGS. 1 and 2 is denoted as a low voltage winding 34 to output a low voltage. A difference from the above example embodiment lies in that the secondary winding 113 in the transformer module 30 shown in this example embodiment includes a high voltage winding 32 and the aforementioned low voltage winding 34. The high voltage winding 32 is to output a high voltage. A numerical range of the low voltage may be, for example, about 12 V to about 16 V, and a numerical range of the high voltage may be, for example, about 290 V to about 490 V.

Specifically, referring to FIGS. 10 and 11, the transformer assembly 3 may include a transformer module 30 which includes four transformer units 31, where the secondary windings 113 of at least a portion of the transformer units 31 simultaneously include both the high voltage winding 32 and the low voltage winding 34.

Further, the high voltage winding 32 may be wound by wires. Accordingly, the high voltage winding 32 may be wound around the first magnetic column 111 together with the primary winding 112.

For example, the high voltage winding 32 and the primary winding 112 may be wound on the bracket 117 in parallel. Further, wire segments spanning the high voltage windings 32 of the adjacent transformer units 31 may also be accommodated in the notch 131 provided on the bracket 117.

Further, the winding directions of the high voltage winding 32 and the secondary winding 113 in the same transformer unit 31 may be the same. Further, the winding directions of the high voltage windings 32 in adjacent transformer units 31 are opposite, and the winding directions of the primary windings 112 in adjacent transformer units 31 are opposite.

Further, the low voltage winding 34 may surround the primary winding 112 and the high voltage winding 32.

In the present example embodiment, the parallel connection of the secondary windings 113 may include at least one of following: the low voltage windings 34 being connected in parallel, or the high voltage windings 32 being connected in parallel, that is, for each transformer unit 31 with the high voltage winding 32, the taps of the secondary high voltage coils wound around the first magnetic columns 111 are connected in parallel.

FIG. 10 and FIG. 11 illustrate an example embodiment that the secondary winding 113 of each transformer unit 31 includes both the high voltage winding 32 and the low voltage winding 34, and the high voltage winding 32 includes four coils connected in series. The output voltage is proportional to the total number of coil turns on the secondary side, which is conducive to increasing a voltage value that the high voltage winding 32 can output, while ensuring an overall small size to meet a power demand of a high voltage load. That is, the transformer module 30 shown in FIGS. 10 and 11 includes five independent secondary windings 113 on the secondary side, which include one high voltage winding 32 and four low voltage windings 34 respectively. In an on-board charging scenario, the one high voltage winding 32 is configured to couple to an on-board high voltage battery, and the four low voltage windings 34 are configured to jointly couple to an on-board low voltage battery.

In an on-board charging application, the example embodiments may enable integration of an On-Board Charger (OBC) with a DC-DC capability, and charging high voltage batteries and low voltage batteries simultaneously.

In some example embodiments, the secondary winding 113 of a portion of the transformer units 31 includes only high voltage winding 32, and/or the secondary winding 113 of a portion of the transformer units 31 includes only low voltage winding 34.

In some example embodiments, the winding directions of the primary winding 112 and the high voltage winding 32 in the same transformer unit 31 may be opposite. During assembly, the primary winding 112 may be wound around the first magnetic column 111 first, and then the high voltage winding 32 may be wound around the outside of the primary winding 112 in an opposite winding direction, or vice versa.

In a second typical application scenario, the transformer assembly 3 shown in the example embodiment of FIGS. 10 and 11 may be applied in an on-board charging scenario. FIG. 12 is a circuit principle diagram of an on-board charging circuit coupled to the transformer assembly 3 shown in FIG. 10.

Specifically, referring to FIG. 12, an input terminal of the transformer assembly 3 may be coupled to a power supply module 33 with an output voltage V from about 379 V to about 430 V, for example. For example, on the primary side, the primary windings 112 of the transformer units 31 may be connected in series to the power supply module 33.

Further, the output terminal 10a of the transformer module 30 may include a high voltage output terminal 10b of the high voltage winding 32 and a low voltage output terminal 10c of the low voltage winding 34, where the high voltage output terminal 10b may be coupled to a high voltage battery 36, and where the low voltage output terminal 10c may be coupled to a low voltage battery 35. The high voltage battery 36 may operate at a DC voltage of about 290 V to about 490 V and a current of about 20 A, for example. The low voltage battery 35 may operate at a DC voltage of about 12 V to about 16 V and a current of about 200 A, for example.

For example, on the secondary side, the taps of the low voltage windings 34 of the transformer units 31 are coupled one by one to the input terminals 22a of the corresponding output inductors 22, and the output terminals 22b of the output inductors 22 are connected in parallel to the low voltage battery 35. For simplicity, FIG. 12 merely illustrates a connection relationship between a group of low voltage windings 34 and the low voltage battery 35.

For example, the high voltage battery 36 may be a single battery or a high voltage battery group including a cascade arrangement of multiple batteries.

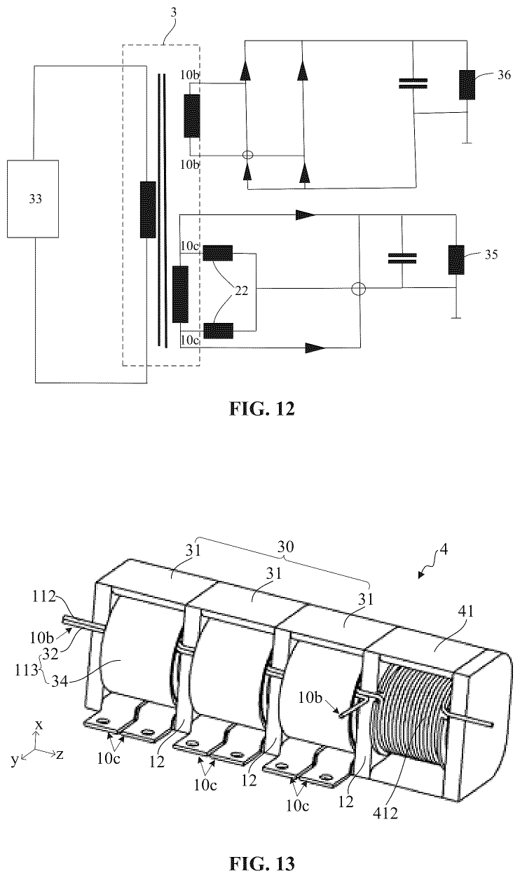

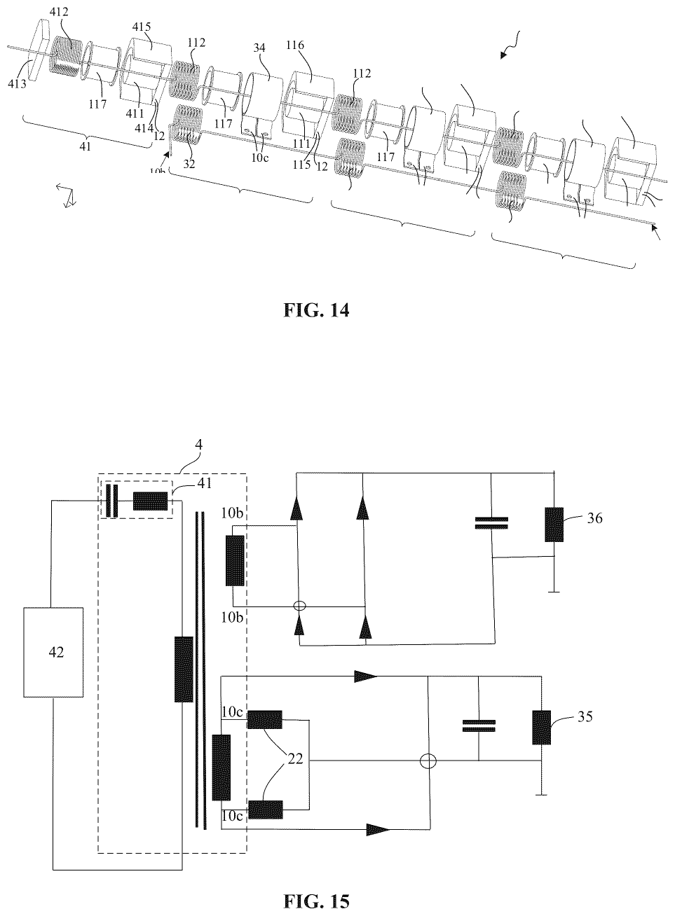

FIG. 13 is a schematic diagram of a transformer assembly 4 according to an example embodiment, and FIG. 14 is an exploded view of the transformer assembly 4 shown in FIG. 13.

In this example embodiment, a difference from the above example embodiment shown in FIGS. 10 and 11 lies in that the number of the transformer units 31 included in the transformer module 30 in the example embodiment is three, and the transformer assembly 4 further includes a first resonant inductor 41 coupled to the input terminal of the transformer module 30. The first resonant inductor 41 may be equivalent to a resonant inductor Lr between the power supply module 25 and the transformer assembly 2 in FIG. 9.

Further, the first resonant inductor 41 may be located along an axial direction of the first magnetic columns 111 (i.e., the z direction in FIG. 13), at either end of the transformer module 30 or between any two adjacent transformer units 31. FIGS. 13 and 14 illustrate an example embodiment in which the first resonant inductor 41 is located at the right end of the transformer module 30 along the z direction. In practice, a relative positional relationship between the first resonant inductor 41 and the transformer module 30 and the transformer units 31 therein can be adjusted as needed.

Further, the first resonant inductor 41 includes a third magnetic column 411 and a second winding 412 wound around the third magnetic column 411. For example, an axial direction of the third magnetic column 411 may be parallel or substantially parallel, within manufacturing and/or measurement tolerances, to the axial direction (i.e., the z direction in the figure) of the first magnetic column 111.

It should be noted that FIG. 13 merely illustrates the second winding 412 as an example. In practice, those skilled in the art can adjust the number of coil turns and winding density of the second winding 412 as needed.

Further, the winding directions of the second winding 412 and the primary winding 112 may be the same or different. For example, the winding direction of the second winding 412 may be opposite to the winding direction of the adjacent primary winding 112, so that magnetic fluxes of the adjacent first resonant inductor 41 and transformer unit 31 cancel each other out in the magnetic core 12, thus reducing the losses and size of the magnetic core.

Further, the first resonant inductor 41 may further include a third cover plate 413, a third base plate 414, and a third side plate 415. The third cover plate 413 and the third base plate 414 are located at two ends of the third magnetic column 411 along the axial direction of the third magnetic column 411, and the third side plate 415 is located between the third cover plate 413 and the third base plate 414.

Shapes and mutual positional relationships of the third cover plate 413, the third base plate 414, and the third side plate 415 can be the same as the first cover plate 114, the first base plate 115, and the first side plate 116 in the above example embodiment shown in FIGS. 1 and 2, and are not repeated here. As a result, the shapes of the first resonant inductor 41 and the transformer module 30 remain consistent, which facilitates device installation and manufacturing.

Further, the third cover plate 413 or the third base plate 414 of the first resonant inductor 41 may share the first base plate 115 or the first cover plate 114 of the adjacent transformer unit 31. Therefore, there may also be a separation magnetic core 12 between the first resonant inductor 41 and the adjacent transformer unit 31 to avoid mutual interference of magnetic paths.

Further, the second winding 412 may be connected in series with the primary windings 112 of the transformer units 31. For example, the second winding 412 is wound from at least the same wire as the primary winding 112 whose tap serves as the input terminal of the transformer module 30. FIGS. 13 and 14 illustrate an example in which the second winding 412 is wound by reusing the wires used to wind each primary winding 112 of the transformer module 30.

During assembly, the second winding 412 may be obtained by winding wires on the third magnetic column 411. Afterward, the remaining wires and wires used to wind the high voltage winding 32 are wound in parallel on each first magnetic column 111 to obtain each primary winding 112 and high voltage winding 32.

In other words, the first resonant inductor 41 may be regarded as the primary winding 112 that is not surrounded on the outside by a copper foil suitable for forming the low voltage winding 34.

Further, the second winding 412 may be wound around the bracket 117 and inserted over the third magnetic column 411 via the bracket 117 to define a sleeve around the third magnetic column 411.

In this example embodiment, integrating the resonant inductor on the primary side of the transformer helps to improve the integration of devices such as the DC-DC converter, thus making the transformer assembly 4 applicable to an LLC topology.

In some example embodiments, the third cover plate 413 (and/or the third base plate 414) of the first resonant inductor 41 may be attached to the first base plate 115 (and/or the first cover plate 114) of the adjacent transformer unit 31 and together form the separation magnetic core 12 that separates the adjacent first resonant inductor 41 and transformer unit 31. Therefore, each transformer unit 11 and first resonant inductor 41 may be manufactured individually, and then the plurality of transformer units 11 and first resonant inductors 41 may be bonded together, which may help to ease manufacturing of the transformer assembly 4.

In some example embodiments, the separation magnetic core 12 may be an additional partitioning plate made of a magnetic core body material, and the first cover plate 114 of the transformer unit 31 and the third base plate 414 of the first resonant inductor 41 are respectively bonded to both sides of the partitioning plate along the z direction.

In a third typical application scenario, the transformer assembly 4 described in the example embodiment shown in FIGS. 13 and 14 may be applied to an LLC topology structure which may be applied to an on-board charging scenario. FIG. 15 is a circuit principle diagram of the LLC topology structure coupled to the transformer assembly 4 shown in FIG. 13 according to an example embodiment.

Specifically, referring to FIG. 15, an input terminal of the transformer assembly 4 may be coupled to a power supply module 42 with an output voltage V from about 379 V to about 430 V, for example. For example, on the primary side, the primary windings 112 of the transformer units 31 are connected in series with the first resonant inductor 41 and are connected to the power supply module 42 via the first resonant inductor 41.

Further, the output terminal 10a of the transformer module 30 may include a high voltage output terminal 10b of the high voltage winding 32 and a low voltage output terminal 10c of the low voltage winding 34. The high voltage output terminal 10b may be coupled to the high voltage battery 36, and the low voltage output terminal 10c may be coupled to the low voltage battery 35. The high voltage battery 36 may operate at a DC voltage from about 290 V to about 490 V and a current of about 20 A, for example. The low voltage battery 35 may operate at a DC voltage from about 12 V to about 16 V and a current of about 200 A, for example.

For example, on the secondary side, the taps of the low voltage windings 34 of the transformer units 31 (i.e., the low voltage output terminal 10c) are coupled one by one to the input terminals 22a of the corresponding output inductors 22, and the output terminals 22b of the output inductors 22 are connected in parallel to the low voltage battery 35. For simplicity, FIG. 15 merely illustrates a connection relationship between a group of low voltage windings 34 and the low voltage battery 35.

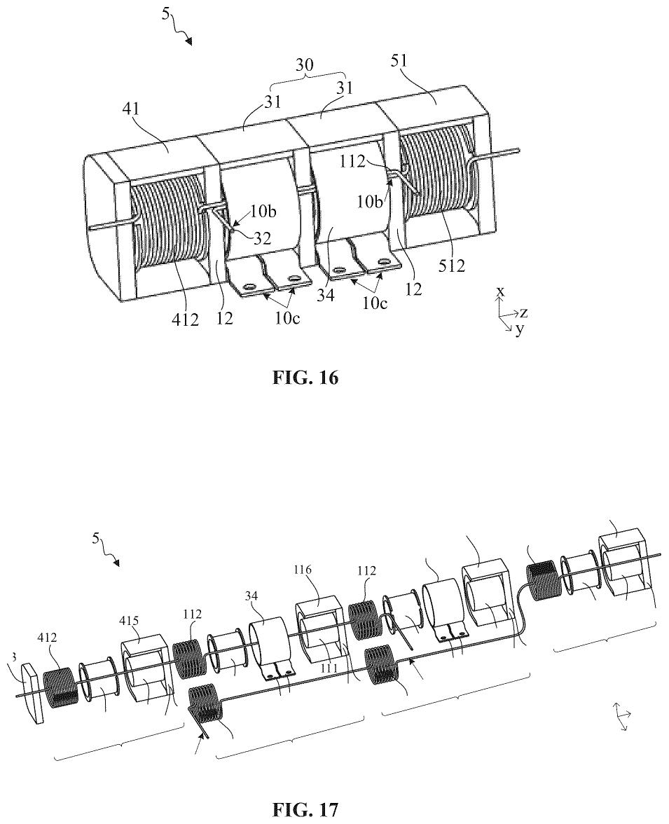

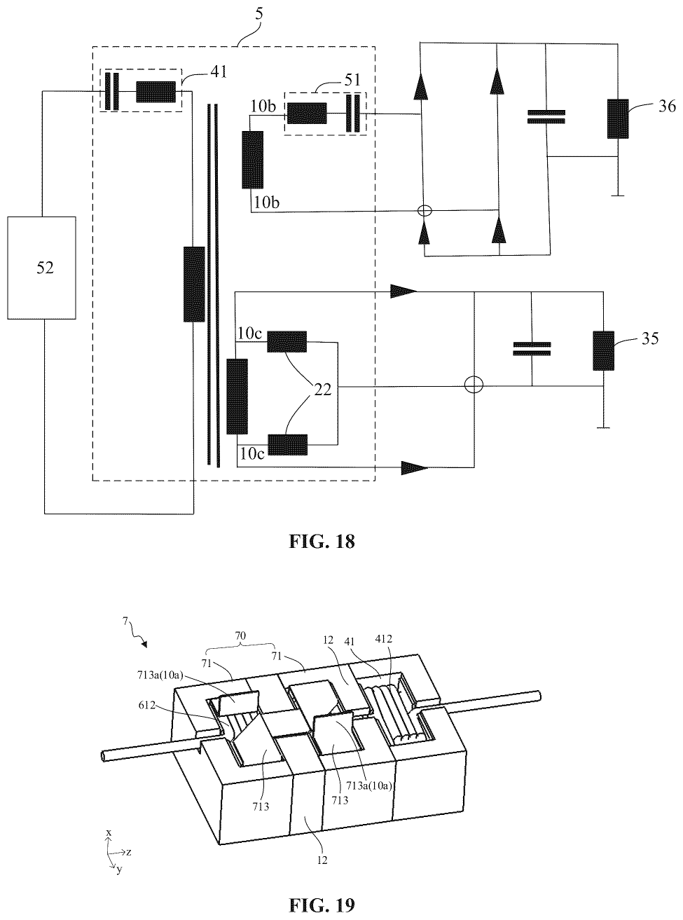

FIG. 16 is a schematic diagram of a transformer assembly 5 according to an example embodiment, and FIG. 17 is an exploded view of the transformer assembly 5 shown in FIG. 16.

In the present example embodiment, a difference from the above example embodiment shown in FIGS. 13 and 14 lies in that the number of the transformer units 31 included in the transformer module 30 in the present example embodiment is two, and in addition to the first resonant inductor 41, the transformer assembly 5 further includes a second resonant inductor 51 coupled to at least one secondary winding 113. The second resonant inductor 51 may be equivalent to the resonant inductor between the high voltage output terminal 10b of the high voltage winding 32 and the high voltage battery 36 (as shown in FIG. 18).

Further, along the axial direction of the first magnetic column 111 (i.e., the z direction in FIG. 17), the second resonant inductor 51 may be located at either end of the transformer module 30, or between any two adjacent transformer units 31, or between the first resonant inductor 41 and the adjacent transformer unit 31, or at either end of the transformer assembly 5. FIG. 16 and FIG. 17 illustrate an example that the first resonant inductor 41 is located at a left side of the transformer module 30 along the z direction, and the second resonant inductor 51 is located at a right side of the transformer module 30 along the z direction. In practice, a relative positional relationship between the first resonant inductor 41 and the second resonant inductor 51, and the transformer module 30 and the transformer units 31 therein can be adjusted as needed.

Further, the second resonant inductor 51 may include a fourth magnetic column 511 and a third winding 512 wound around the fourth magnetic column 511. For example, an axial direction of the fourth magnetic column 511 may be parallel or substantially parallel, within manufacturing and/or measurement tolerances, to an axial direction of the first magnetic column 111 (i.e., the z direction in the figure).

It should be noted that FIG. 16 merely exemplarily illustrates the third winding 512. In practice, the number of coil turns and winding density of the third winding 512 can be adjusted as needed.

Further, the winding directions of the third winding 512 and the primary winding 112 may be the same or different. The winding directions of the third winding 512 and the second winding 412 may be the same or different. The winding directions of the third winding 512 and the high voltage winding 32 may be the same or different.

For example, the winding direction of the third winding 512 may be opposite to the winding directions of the adjacent primary winding 112, the high voltage winding 32, and the second winding 412, so that magnetic fluxes of the adjacent second resonant inductor 51 and transformer unit 31 (and/or the first resonant inductor 41) cancel each other out in the separation magnetic core 12, thus reducing the losses and size of the magnetic cores.

Further, the second resonant inductor 51 may further include a fourth cover plate 513, a fourth base plate 514, and a fourth side plate 515. The fourth cover plate 513 and the fourth base plate 514 are located at two ends of the fourth magnetic column 511 along an axial direction of the fourth magnetic column 511, and the fourth side plate 515 is located between the fourth cover plate 513 and the fourth base plate 514.

Details of respective shapes and mutual positional relationships of the fourth cover plate 513, the fourth base plate 514, and the fourth side plate 515 can be the same as the first cover plate 114, the first base plate 115, and the first side plate 116 in the present example embodiment shown in FIGS. 1 and 2, and are not repeated here. Therefore, the shapes of the second resonant inductor 51 and the transformer module 30 remain consistent, which facilitates installation and manufacturing of devices.

Further, the fourth cover plate 513 or the fourth base plate 514 of the second resonant inductor 51 may share the first base plate 115 or the first cover plate 114 of the adjacent transformer unit 31. Therefore, there may also be a separation magnetic core 12 between the second resonant inductor 51 and the adjacent transformer unit 31 to avoid mutual interference of magnetic paths.

In a scenario where the first resonant inductor 41 and the second resonant inductor 51 are arranged adjacently, the fourth cover plate 513 may share the third base plate 414, or the fourth base plate 514 may share the third base plate 415.

Further, the high voltage windings 32 and second resonant inductors 51 may have an associated relationship, and the second resonant inductors 51 and the corresponding high voltage windings 32 are connected in series.

For example, the number of the second resonant inductors 51 may be equal to the number of the high voltage windings 32, and the second resonant inductors 51 and the high voltage windings 32 may be arranged in one-to-one correspondence. That is, each second resonant inductor 51 and the corresponding high voltage winding 32 are connected in series. For example, the third winding 512 is wound by the same wire as the high voltage winding 32.

For another example, the number of the high voltage windings 32 and the number of the second resonant inductors 51 may be different, and two high voltage windings 32 may correspond to the same second resonant inductor 51.

FIGS. 16 and 17 illustrate an example embodiment that the secondary winding 113 includes one high voltage winding 32 (including two coils connected in series). Accordingly, the number of the second resonant inductor 51 may also be one, and the second resonant inductor 51 is connected in series with the high voltage output terminal 10b. In a scenario of multiple parallel-connected high voltage windings 32, the high voltage output terminal 10b of each high voltage winding 32 is connected in series with the corresponding second resonant inductor 51.

During assembly, wires are wound around the third magnetic column 411 to obtain the second winding 412 to further obtain the first resonant inductor 41. Afterward, the remaining wires and the wires used to wind the high voltage winding 32 are wound in parallel around each first magnetic column 111 to obtain each primary winding 112 and high voltage winding 32. Afterward, the wires used to wind the high voltage winding 32 continues to be wound around the fourth magnetic column 511 to obtain the third winding 512 to further obtain the second resonant inductor 51. Afterward, the low voltage winding 34 is inserted over each first magnetic column 111 to define a sleeve around each first magnetic column 111, to thus provide each transformer unit 31. Finally, each transformer unit 31, each first resonant inductor 41, and each second resonant inductor 51 are combined in sequence to obtain the transformer assembly 5 shown in FIG. 16.

In other words, the second resonant inductor 51 may be regarded as the high voltage winding 32 which is neither enclosed by the copper foil suitable for forming the low voltage winding 34 on the outside, nor surrounded by the secondary winding 113.

Further, the third winding 512 may be wound around the bracket 117 and inserted over the fourth magnetic column 511 via the bracket 117 to define a sleeve around the fourth magnetic column 511.

In these example embodiments, the resonant inductor on the primary side, the transformer, and the resonant inductor on the secondary side can be integrated together, which is conducive to improving the integration of devices (such as a DC-DC converter), thus making the transformer assembly 5 applicable to a CLLC topology. Further, the second resonant inductor 51 may prevent the devices connected with the second resonant inductor 51 (such as the high voltage battery 36) from being damaged during zero-voltage turn-on/turn-off, thus effectively saving losses.

In some example embodiments, the fourth cover plate 513 (and/or the fourth base plate 514) of the second resonant inductor 51 may be attached to the first base plate 115 (and/or the first cover plate 114) of the adjacent transformer unit 31 to together form the separation magnetic core 12 that separates the adjacent second resonant inductor 51 and transformer unit 31. The fourth cover plate 513 (or the fourth base plate 514) of the second resonant inductor 51 may be attached to the third base plate 414 (or the third cover plate 413) of the adjacent first resonant inductor 41 to together define the separation magnetic core 12 that separates the adjacent second resonant inductor 51 and first resonant inductor 41. Therefore, each transformer unit 11, each first resonant inductor 41 and each second resonant inductor 51 may be manufactured individually and then bonded together, which may help to facilitate manufacturing of the transformer assembly 5.

In some example embodiments, the separation magnetic core 12 may be an additional partitioning plate made of a magnetic core body material. The first cover plate 114 of the transformer unit 31 and the fourth base plate 514 of the second resonant inductor 51 are respectively bonded to both sides of the partitioning plate along the z direction.

In a fourth typical application scenario, the transformer assembly 5 shown in the example embodiment illustrated in FIGS. 16 and 17 may be applied in a CLLC topology structure which may be applied in an on-board charging scenario. FIG. 18 is a circuit diagram of a CLLC topology coupled to the transformer assembly 5 in FIG. 16.

Specifically, referring to FIG. 18, an input terminal of the transformer assembly 5 may be coupled to a power supply module 52 with an output voltage V from about 379 V to about 430 V, for example. For example, on the primary side, the primary winding 112 of each transformer unit 31 is connected in series with the first resonant inductor 41 and is further connected to the power supply module 52 via the first resonant inductor 41.

Further, the output terminal 10a of the transformer module 30 may include a high voltage output terminal 10b of the high voltage winding 32 and a low voltage output terminal 10c of the low voltage winding 34. The high voltage output terminal 10b may be connected in series with the second resonant inductor 51 and further connected to the high voltage battery 36 through the second resonant inductor 51, and the low voltage output terminal 10c may be coupled to the low voltage battery 35. The high voltage battery 36 may operate at a DC voltage of 290 V to 490 V and a current of about 20 A, for example. The low voltage battery 35 may operate at a DC voltage of about 12 V to about 16 V and a current of about 200 A, for example.

For example, on the secondary side, the taps of the low voltage winding 34 of each transformer unit 31 (i.e., the low voltage output terminals 10c) are coupled one by one to the input terminals 22a of the corresponding output inductors 22, and the output terminal 22b of each output inductor 22 is connected in parallel to the low voltage battery 35. For simplicity, FIG. 18 merely illustrates a connection relationship between a group of low voltage windings 34 and the low voltage battery 35.

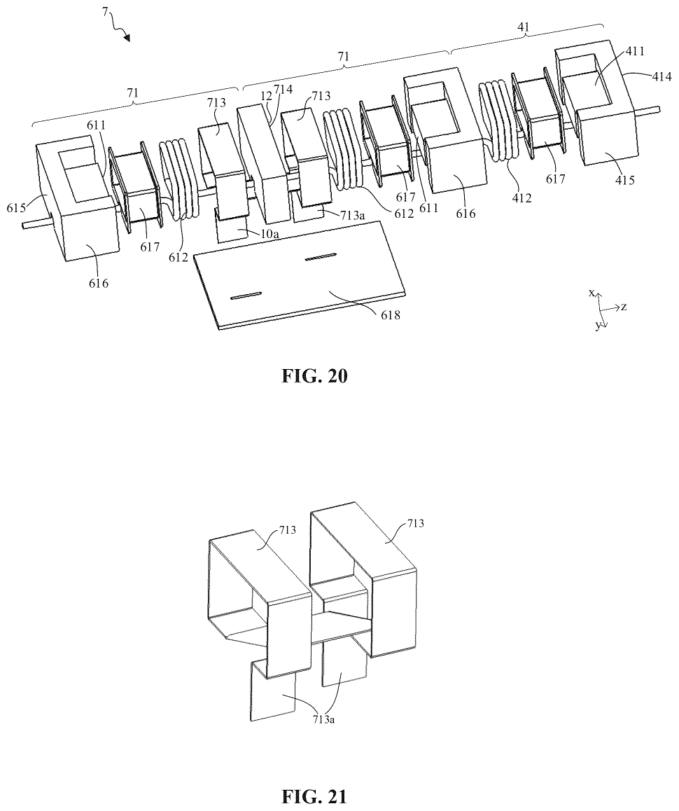

FIG. 19 is a schematic diagram of a transformer assembly 7 according to an example embodiment, FIG. 20 is an exploded view of the transformer assembly 7 shown in FIG. 19, and FIG. 21 is a schematic diagram of secondary windings 713 shown in FIG. 19.

In the present example embodiment, a difference from the above example embodiment shown in FIGS. 1 and 2 lies in that the secondary windings 713 of the transformer module 70 are connected in series. It should be noted that to more explicitly illustrate the secondary windings 713 connected in series, a support layer 618 is not shown in FIG. 19 but is shown in FIG. 20.

Accordingly, in this example embodiment, the number of output terminals 10a of the transformer module 70 is two.

Further, the present example embodiment is illustrated using the transformer module 70 including two secondary windings 713 as an example. The two secondary windings 713 may be wound from a same copper foil, as shown in FIG. 21. For example, during winding, the copper foil is first bent into a quadrilateral in a plane defined by the x direction and the y direction to obtain the first secondary winding 713, and then the copper foil is folded along the z direction. The folded copper foil is extended for a certain distance along the z direction and then folded along the y direction, and then the copper foil is bent into a quadrilateral in the plane defined by the x direction and the y direction to obtain the second secondary winding 713.

The secondary windings 713 connected in series include two taps 713a.

For example, along the z direction, the two taps 713a may not be on a same straight line. In the present example embodiment, the bending directions of the two secondary windings 713 when bent in the plane defined by the x direction and the y direction may be the same.

For another example, along the z direction, the two taps 713a may be on the same straight line. In the present example embodiment, the bending directions of the two secondary windings 713 when bent in the plane defined by the x direction and the y direction may be opposite.

In the present example embodiment, the secondary windings 713 may be connected in series, so that the transformer module 70 may operate in both directions, that is, the transformer module 70 may include primary side input and secondary side output or may include secondary side input and primary side output. As a result, the transformer module 70 may better meet the requirements of transformer applications in the solar charging field. Similarly, in the technical field of electric vehicles, the solution of connecting the secondary windings 713 in series as described in the present example embodiment can also be used.

Further, a difference between the transformer assembly 7 shown in the present example embodiment and the above example embodiment shown in FIGS. 1 and 2 lies in that the first magnetic column 611, the bracket 617, the primary winding 612, and the secondary winding 713 of the transformer module 70 are all rectangular parallelepiped, while the first magnetic column 111, the bracket 117, the primary winding 112, and the secondary winding 113 of the transformer module 10 in the above example embodiment shown in FIGS. 1 and 2 are all roughly tubular (or cylindrical).

A radial direction r of the first magnetic column 611 may be understood as a direction from the first magnetic column 611 to the first side plate 616 on a plane perpendicular to an arrangement direction (i.e., the z direction) of each transformer unit 71.

Further, the first side plate 616 is provided on opposite sides of the first magnetic column 611 along the y direction to surround half or approximately half, within manufacturing and/or measurement tolerances, of an outer peripheral surface of the first magnetic column 611. Therefore, upper and lower sides of the transformer unit 71 along the x direction have an open structure, and the increase in exposed portions is conducive to obtaining better heat dissipation effect. Further, as the top and bottom of the transformer assembly 7 along the x direction are not provided with magnetic cores, it is possible to adjust height of the transformer assembly 7 along the x direction.

Further, both the first base plate 615 and the first cover plate 714 may be rectangular plates, and their lengths along the x direction are less than their lengths along the y direction. Therefore, if two sides of the transformer module 70 not provided with the first side plate 616 are regarded as a top surface and a bottom surface, the overall outer contour of the transformer module 70 can be regarded as a rectangular parallelepiped that is flatter than a cube, which facilitates reducing overall height of the transformer module 70 so that the transformer module 70 can be arranged in a location with a small space.

Further, two adjacent transformer units 71 may share the same first cover plate 714 as the separation magnetic core 12. For example, referring to FIG. 20, the E-shaped core structure of two transformer units 71 may be arranged oppositely along the z direction to share the same separation magnetic core 12 as their respective first cover plates 714. A shape of the first cover plate 714 may be set with reference to a shape of the first base plate 615.

Further, a support layer 618 may be provided on a side of the transformer module 70 from which the tap 713a of the secondary winding 713 protrudes. The side may be a side on which the first side plate 616 is not provided. The tap 713a may pass through the support layer 618 to extend outside the transformer assembly 7. The support layer 618 may be made of fiberglass epoxy resin, such as FR4. Providing the support layer 618 between the transformer assembly 7 and a PCB on which the transformer assembly 7 is installed is conducive to strengthening mechanical support strength of the transformer assembly 7.

Further, the transformer assembly 7 may further include components in the foregoing example embodiments as shown in FIGS. 5 to 8, 10, 11, 13, 14, 16, and 17. For example, the transformer assembly 7 may also include the first resonant inductor 41 in the above example embodiment shown in FIGS. 13 and 14. In addition, an outline shape of the first resonant inductor 41 may be set with reference to an outline shape of the transformer unit 71. For another example, the transformer assembly 7 may also include the output inductor array 21 in the above example embodiment as shown in FIGS. 5 to 8. In this case, the output inductor array 21 includes two output inductors 22 which are respectively connected to the two taps 713a of the secondary winding 713 that are connected in series.

In some example embodiments, the secondary winding 713 may be wound from wires to better withstand high voltage input or output.

In some example embodiments, for the plurality of secondary windings 113 included in the transformer module 10, there may be a first number of secondary windings 113 connected in series using the solution in the above example embodiment shown in FIGS. 19 to 21, while the remaining second number of secondary windings 113 are connected in parallel as shown in the above example embodiments of FIGS. 1 and 2 or 10 and 11. In the example embodiments, the number of the output terminals 10a of the transformer module 10 may be equal to the total number of taps 113a of the second number of secondary windings 113 plus two.

Further, as the secondary windings 113 may be connected in parallel or in series, the transformer assemblies 1 to 7 provided in the example embodiments are more flexible in configuration, and can be configured to the requirements of different application scenarios.

Although specific example embodiments have been described above, these example embodiments are not intended to limit the scope of the present disclosure, even where a single example embodiment is described with respect to specific features only. Examples of features provided in the present disclosure are intended to be illustrative but not limiting unless expressly stated otherwise. In specific implementations, technical features of one or more dependent claims may be combined with technical features of the independent claims, and may be combined in any appropriate manner rather than only through specific combinations listed in the claims.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A transformer assembly comprising:
a transformer module including:
a plurality of transformer units, each of the plurality of transformer units including:
a first magnetic column extending in an axial direction,
a primary winding and a secondary winding respectively wound around the first magnetic column, the primary winding being between the secondary winding and the first magnetic column along a radial direction of the first magnetic column;
a first cover plate, a first base plate, and a first side plate, the first cover plate and the first base plate being respectively located at two ends of the first magnetic column along the axial direction, and the first side plate being located between the first cover plate and the first base plate; and
a transformer separation magnetic core provided between adjacent transformer units of the plurality of transformer units; wherein
the primary windings of the plurality of transformer units are connected in series; and
the plurality of transformer units are arranged in sequence along the axial direction.

2. The transformer assembly according to claim 1, wherein the first side plate surrounds approximately half to approximately three quarters of an outer circumferential surface of the first magnetic column along a circumferential direction of the first magnetic column.

3. The transformer assembly according to claim 1, wherein the adjacent transformer units include a first transformer unit and a second transformer unit, and the first base plate of the first transformer unit is the first cover plate of the second transformer unit.

4. The transformer assembly according to claim 3, wherein the transformer separation magnetic core is the first base plate of the first transformer unit and the first cover plate of the second transformer unit.

5. The transformer assembly according to claim 1, wherein the secondary windings of the plurality of transformer units are connected in parallel and/or in series.

6. The transformer assembly according to claim 1, wherein the secondary winding includes:
a high voltage winding to output a high voltage; and/or
a low voltage winding to output a low voltage.

7. The transformer assembly according to claim 6, wherein the secondary windings of at least a portion of the plurality of transformer units include both the high voltage winding and the low voltage winding.

8. The transformer assembly according to claim 1, further comprising:
an output inductor array including a plurality of output inductors;
an inductor separation magnetic core between adjacent output inductors of the plurality of output inductors; and
an input terminal of each of the plurality of output inductors coupled to a corresponding output terminal of the transformer module.

9. The transformer assembly according to claim 8, wherein a number of output terminals of the transformer module corresponds to a number of taps of the secondary windings, and a number of the plurality of output inductors is equal to the number of the output terminals of the transformer module.

10. The transformer assembly according to claim 8, wherein
the plurality of output inductors are arranged in sequence along a first direction parallel or substantially parallel to the axial direction of the first magnetic column;
each of the plurality of output inductors includes:
a second magnetic column and a first winding wound around the second magnetic column; and
a second cover plate, a second base plate, and a second side plate; wherein
the second cover plate and the second base plate are respectively located at two ends of the second magnetic column along an axial direction of the second magnetic column, and the second side plate is located between the second cover plate and the second base plate.

11. The transformer assembly according to claim 10, wherein the adjacent output inductors include a first output inductor and a second output inductor, and the second base plate of the first output inductor is the second cover plate of the second output inductor.

12. The transformer assembly according to claim 1, further comprising a first resonant inductor coupled to an input terminal of the transformer module; wherein
the first resonant inductor is located along the axial direction at either end of the transformer module or between any two adjacent transformer units of the plurality of transformer units.

13. The transformer assembly according to claim 12, wherein the first resonant inductor includes:
a second magnetic column and a first winding wound around the second magnetic column; and
a second cover plate, a second base plate, and a second side plate; wherein
the second cover plate and the second base plate are respectively located at two ends of the second magnetic column along an axial direction of the second magnetic column, and the second side plate is located between the second cover plate and the second base plate.

14. The transformer assembly according to claim 13, wherein the first winding is connected in series with the primary windings of the plurality of transformer units.

15. The transformer assembly according to claim 13, wherein
the plurality of adjacent transformer units includes an adjacent transformer unit that is adjacent to the first resonant inductor; and
the second cover plate or the second base plate of the first resonant inductor is the first base plate or the first cover plate of the adjacent transformer unit.

16. The transformer assembly according to claim 1, further comprising a first resonant inductor coupled to at least one secondary winding; wherein
the first resonant inductor is located along the axial direction at either end of the transformer module or between any two adjacent transformer units of the plurality of transformer units.

17. The transformer assembly according to claim 16, wherein the first resonant inductor includes:
a second magnetic column and a first winding wound around the second magnetic column; and
a second cover plate, a second base plate, and a second side plate; wherein
the second cover plate and the second base plate are respectively located at two ends of the second magnetic column along an axial direction of the second magnetic column, and the second side plate is located between the second cover plate and the second base plate.

18. The transformer assembly according to claim 17, wherein the at least one secondary winding includes a high voltage winding, and the first resonant inductor and the high voltage winding are connected in series.

19. The transformer assembly according to claim 17, wherein
the plurality of adjacent transformer units includes an adjacent transformer unit that is adjacent to the first resonant inductor; and
the second cover plate or the second base plate of the first resonant inductor is the first base plate or the first cover plate of the adjacent transformer unit.

20. The transformer assembly according to claim 16, further comprising a second resonant inductor coupled to an input terminal of the transformer module; wherein
the second resonant inductor is located along the axial direction at either end of the transformer module, or between any two adjacent transformer units of the plurality of transformer units, or between the first resonant inductor and an adjacent transformer unit of the plurality of transformer units.
